(19) United States
(12) Patent Application Publication
(10) Pub. No.: US 2017/0089201 A1
(43) Pub. Date: Mar. 30, 2017

(54) HYBRID PNEUMATIC / INTERNAL COMBUSTION ROTARY ENGINE

(71) Applicant: Rasoul Farazifard, Richmond (CA)

(72) Inventor: Rasoul Farazifard, Richmond (CA)

(21) Appl. No.: 14/864,871

(22) Filed: Sep. 25, 2015

(51) Int. Cl. F01B 29/04; F01C 19/10; F02B 55/14

(52) U.S. Cl. CPC F01B 29/04; F02B 55/14; F01C 19/10

(57) ABSTRACT

A hybrid engine comprises a housing and at least one rotor. The engine employs tongue and groove system to generate rotational movement. As the rotor pivots, reciprocating tongues slide into and out of the grooves. In pneumatic mode, introduction of compressed air forwardly into the grooves drives the rotor. Meanwhile, the air exhaust is cleared from the grooves rearwardly. In internal combustion mode, compression and air intake strokes start and end at the same time in a groove. Combustion and exhaust strokes occur simultaneously in the next groove arriving at the combustion chamber.

### CROSS-REFERENCE TO RELATED APPLICATIONS

Not Applicable

### BACKGROUND OF THE INVENTION

1. Field of the Invention

The present invention relates generally to hybrid pneumatic-combustion engines. This device also relates to rotary internal combustion engines.

2. Description of the Related Art

Similar to reciprocating piston engines, rotary engines are internal combustion engines that employ a rotary design to convert the energy of expanding combustion gases into rotating motion. Examples of rotary engines are disclosed in U.S. Pat. No. 3,306,269, 3,793,998, 3,855,977, 4,066,044, 4,072,132, 4,401,070, 5,261,365, 5,551,853, 6,164,263, 6,899,075B2, and 2013/0228150A1. The most well-known application for rotary engine is the Wankel engine (U.S. Pat. No. 2,988,065) which was produced for Mazda automobiles.

It is expected that internal combustion engines to be the main power source to propel vehicles for many years to come. It is well known that the internal combustion engines have low fuel efficiency, and are the major source of air pollution. In this regard, and in order to improve the fuel efficiency, hybrids and electric vehicles have gotten many attentions; see U.S. Pat. No. 5,191,766, 5,343,970A, and 8,365,699B2. However, the drawbacks of the hybrid electric-combustion and electric vehicles are high battery costs, weight, and maintenance requirements.

### BRIEF SUMMARY OF THE INVENTION

Accordingly, the primary object of the present invention is to provide a hybrid engine which can operate alternatively as a pneumatic motor and as an internal combustion engine. Similar to many other hybrid engines, this invention employs an electronic management system that regulates the operating modes based on the current driving needs, and in order to optimize energy efficiency. The present engine runs in the internal combustion mode when more power is required, and in the pneumatic mode when less power is needed.

Another object of this invention is to provide a rotary engine with a novel configuration which is simple to design, more efficient, and easy to make. In many combustion rotary engines such as Wankel engine, the gas expansion caused by combustion, especially during starting, could kick the engine to run simultaneously in both standard and reverse rotations, and consequently reduce the efficiency. While, the expansion of gases in this invention drives the rotor only in one direction, and kick back is not possible,

### BRIEF DESCRIPTION OF THE DRAWINGS

FIG. 1 is a perspective exploded view of the hybrid rotary engine according to an embodiment of the invention.

FIG. 2 is a transverse sectional view of the rotor cut through the center of the pressure grooves and perpendicular to the central shaft shown in FIG. 1.

FIG. 3 is a transverse sectional view of the assembled engine cut through the center of the intake and exhaust passages, and perpendicular to the central shaft which is shown in FIG. 1.

FIGS. 4 to 6 are transverse sectional views of the engine, similar to FIG. 3, showing different stages of the engine's working cycle.

### DETAILED DESCRIPTION OF THE INVENTION

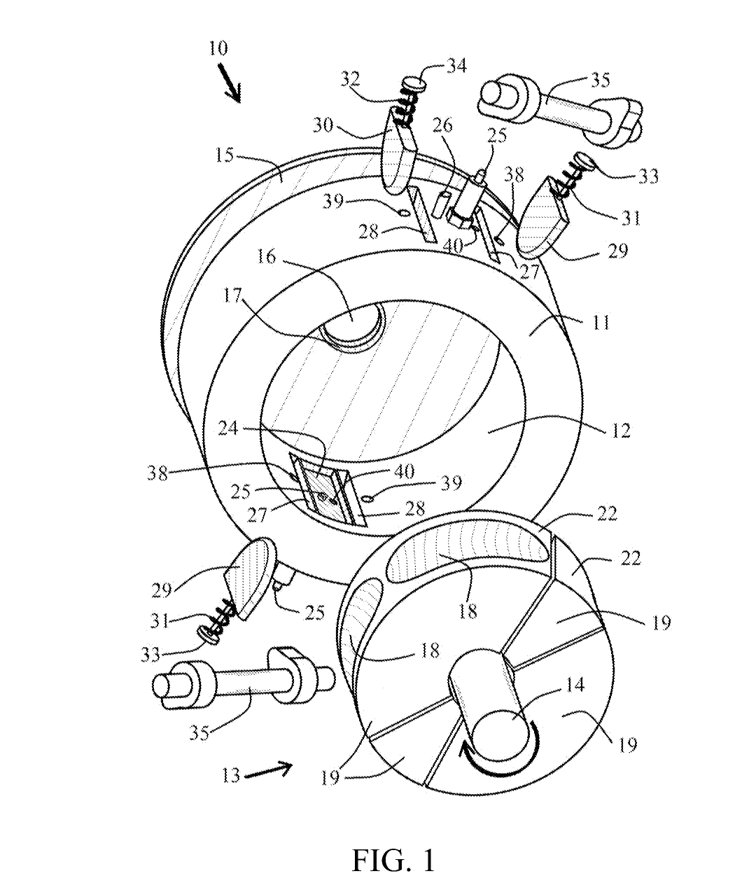

As shown in FIG. 1, rotary engine 10 has the following principal components: (1) a housing 11 which has a cylindrical inner surface 12, and is for housing other components, (2) an inner body or rotor 13 which is rotatable within the housing 11 cavity, and is supported by a central shaft 14, (3) two plates 15 for enclosing both sides of the housing 11 (only one plate has been shown in FIG. 1). Each plate 15 has a bore 16 through which the central shaft 14 projects outward, and is supported by means of a bearing 17 on each plate 15.

Referring to FIG. 1, the rotor 13 has one or a plurality of semi-annular grooves 18 which are open toward the inner surface of the housing 12. These grooves 18 are comparable to the cylinders on the conventional engines, and will be called pressure grooves 18 hereafter. The pressure grooves 18 have elongated shapes, and are perpendicular to the axis of rotation.

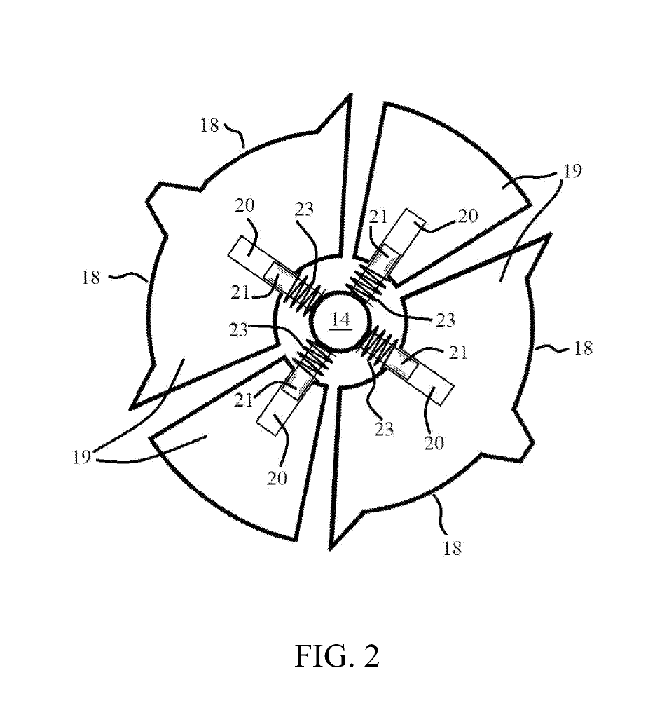

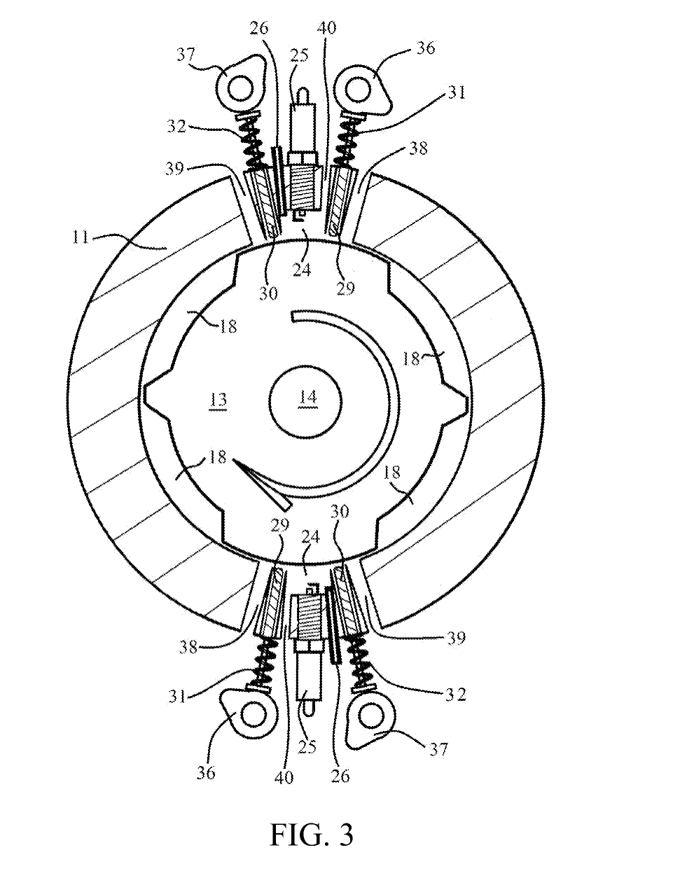

For small engines, the rotor 13 is made of one cylindrical-shaped piece which is mounted on central shaft 14. The diameter of the rotor 13 is approximately equal to the internal diameter of the housing 11. For larger engines, the rotor 13 is made of a plurality of pie-shaped elements 19, as shown in FIG. 2. In this case, the rotor's elements 19 have holes 20 on their inner sides in such that the holes 20 are facing perpendicularly to the central shaft 14. Through their holes 20, the rotor's elements 19 are slidably mounted on bars 21 radiating from the central shaft 14. Outer surfaces of the rotor's elements 22 are normally held in sealing engagement with the inner surface of the housing 12 by centrifugal force when the engine is running. In order to augment the seal between the inner surface of the housing 12 and the outer surface of the rotor's elements 22, springs 23 are mounted around the bars 21 between the central shaft 14 and the rotor's elements 19. The springs 23 push the rotor's elements 19 against the central shaft 14 toward the inner surface of the housing 12. Alternatively and instead of the springs 23, hydraulic or pneumatic pressure can be employed to create a more stable seal between the outer surface of the rotor's elements 22 and the inner surface of the housing 12, using a pressure sensor (not shown). Liquid lubrication is applied between the outer surface of the rotor 22 and the inner surface of the housing 12 to reduce friction and wear. For simplicity and as an example of small engines, the rotor 13 is shown as one piece in FIGS. 3-6.

Referring again to FIG. 1, a cavity, located at the peripheral inner surface of the housing, acts as the combustion chamber 24. The combustion chamber 24 has normally a cuboid shape but it could have other shapes as well. In the illustrated embodiment of FIGS. 3-6, two combustion chambers 24 on the housing 11 have been shown but that number is understood as not being intended as a limitation of the invention. Spark plugs 25 are mounted on the housing 11, and projected into the combustion chambers 24. The engine 10 also has fuel injectors 26 which extend through the housing 11 and into the combustion chamber 24. The fuel injectors 26 are employed to inject a combustible fuel in the combustion chamber 24 at the proper time in relation to the working cycle.

The housing 11 has a plurality of slots which extend completely through the housing 11, and perpendicularly and radially to the central shaft 14. There are one slot 27 at the front side, and one slot 28 at the rear side of each combustion chamber 24. Henceforward, the terms “front” and “rear” are used with reference to the direction of rotation. As seen in FIGS. 1 and 3-6, the rotor 13 is driven in a clockwise direction, that is, in the direction of arrows. Each slot 27 and 28 is shaped to slidably receive a tongue in sealing contact. The tongues that go into the front slots 27 and rear slots 28 will be respectively called compression tongues 29 and combustion tongues 30. The tongues 29 and 30 are equivalent to the pistons on the reciprocal engines. When the engine 10 is running, the tongues 29 and 30 reciprocate within their respective slots 27 and 28, and into the pressure grooves 18. Tips of the tongues 29 and 30, and wall of the pressure grooves 18 have the same shapes, which are normally U shape but other shapes such as V or rectangular could be used as well. When moving into and along the pressure grooves 18, the tips and sides of the tongues 29 and 30 form seals with the wall of the pressure grooves 18.

As viewed in FIGS. 3-8, return springs 31 and 32 supported by upper body of the tongues 33 and 34 acts against the housing 11 to urge the tongues 29 and 30 out of their respective slots 27 and 28 in the housing body 11, and away from the rotor 13. Camshafts 35 are employed for timely operation of the tongues 29 and 30. The camshafts 35 are movably connected to the central shaft 14 by timing gears (not shown) and chain assembly (not shown). When cam lobes 36 and 37 engage the upper body of the tongues 33 and 34, the tongues 29 and 30 are pushed into their respective slots 27 and 28 toward the rotor 13, and into the pressure grooves 18 against the action of their return springs 31 and 32. As the cam lobes 36 and 37 rotate further, the return springs 31 and 32 act to pull back the tongues 29 and 30 into their resting positions in their respective slots 27 and 28. For maximum efficiency of the engine 10, it is understood that the cam lobes 36 and 37 should be shaped with considerable accuracy to keep the tip of the tongues 29 and 30 in sealing contact with the wall of pressure grooves 18 while the rotor 13 is running. Instead of camshaft system, any other mechanical design for movement of the tongues 29 and 30 would be equally satisfactory.

Referring to FIG. 3, the housing 11 also includes a plurality of passages. Air intake passages 38 are located adjacent to and at the front of the compression slots 27. Fuel exhaust passages 39 are disposed next to and at the rear of the combustion slots 28. Compressed air exhaust passages 40 are placed at the rear of the compression slots 27, and into the combustion chambers 24. Poppet valves are used to control the passage of the gases into and out of the engine 10. Camshafts are employed to operate the poppet valves at proper cycle. Since this operation is very well known, the valves operating camshaft and poppet valves are omitted from the drawings for clarity. Alternatively and instead of the camshafts, hydraulic or pneumatic actuators can also be deployed to regulate the gases flow through the intake and exhaust passages.

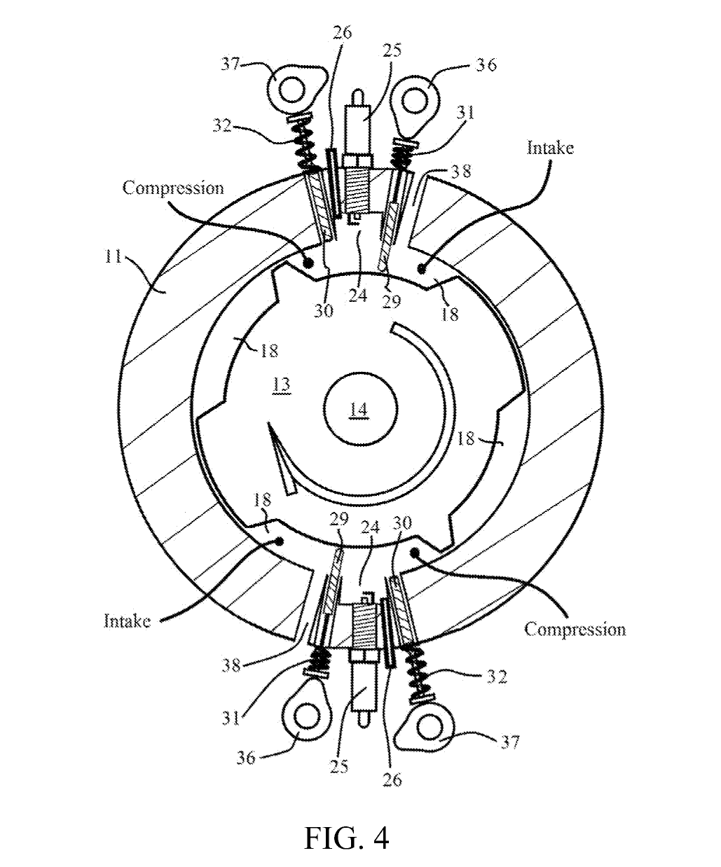

The operation of the engine 10 is best understood with reference to FIGS. 4-6. The engine 10 is normally started by imparting initial rotation to the central shaft 14 using a suitable starter motor (not shown). When operating in the combustion mode, the engine 10 uses the pressure created by burning fuel to run, similar to piston engines. The engine 10 of the present invention is a four-stroke engine, which each stroke has two phases of operation; intake/compression and combustion/exhaust. Every other pressure groove 18 that passes a combustion chamber 24 serves for either the intake/compression phase or combustion/exhaust phase while the phases occur one after another at each combustion chamber 24. As soon as the tongues 29 and 30 are pushed into the pressure grooves 18 by their corresponding cam lobes 36 and 37, the pressure grooves 18 are divided into two spaces; front and rear spaces. When the compression tongues 29 enter into the pressure grooves 18, the intake and compression respectively happen in the front and rear spaces of the compression tongues 29. When the combustion tongues 30 enter into the pressure grooves 18, the combustion and exhaust respectively occur in the front and rear spaces of the combustion tongues 30.

Referring to FIG. 4, as the compression tongues 29 go into the pressure grooves 18, air is received into the front space of the pressure grooves 18 through the opened air intake passages 38. The air is kept in the pressure grooves 18 for the next stroke. At the same time as the pressure grooves 18 continue to move forward, and pass by the compression tongues 29, the air trapped in the pressure grooves 18 at the previous stroke is compressed and guided to the combustion chambers 24. The compression is due to decreasing volume of the rear space of the pressure grooves 18 when the pressure grooves 18 are moving forward. At the end of intake/compression phase, the compression tongues 29 are placed at its resting position in the housing 11.

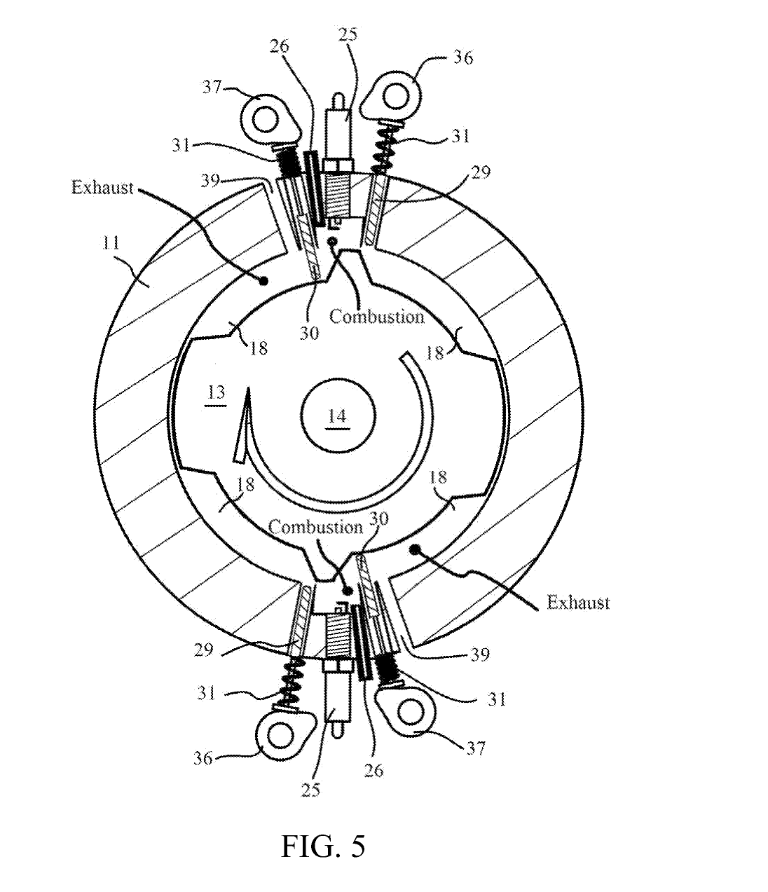

As shown in FIG. 5, when the next pressure grooves 18 reach the combustion chambers 24, this time the combustion tongues 30 are pushed into the pressure grooves 18 by their corresponding cam lobes 37. The fuel is then injected by the fuel injectors 26 in the combustion chambers 24, and the air/fuel mixture is ignited by the spark plugs 25 to provide the power stroke at the front of the combustion tongues 30. At this moment, the volumes of the front spaces of the combustion tongues 30 are close to their minimum. The pressure of combustion forces the pressure grooves 18 to move in the direction that makes the front spaces of the pressure grooves 18 grow in volume. The combustion gases continue to expand, moving the rotor 13, and creating power, until the pressure grooves 18 completely pass the combustion tongues 30. In the meantime that the combustion tongues 30 are inside and moving along the pressure grooves 18, the fuel exhaust passages 39 are open, and the combustion tongues 30 rearwardly push the exhaust gases produced at the previous stroke, out of the pressure grooves 18. It should be noted that the compressed air exhaust passages 40 are closed at all time during the combustion mode.

It is worth noting that in the present invention, the number of combustion strokes for every rotation of the central shaft 14 can be calculated using the following equation; S=(C*G)/2, where C is the number of combustion chambers 24 on the housing 11, G is the number of pressure grooves 18 on the rotor 13, and S is equal to the number of power stroke per central shaft 14 revolution. Therefore, an engine 10 with one combustion chamber 24 and one pressure groove 18 completes one combustion stroke for every two rotations of the central shaft 14. While, an engine 10 with two combustion chambers 24 and two pressure grooves 18, as shown in the drawings, has two power strokes per one revolution of the central shaft 14.

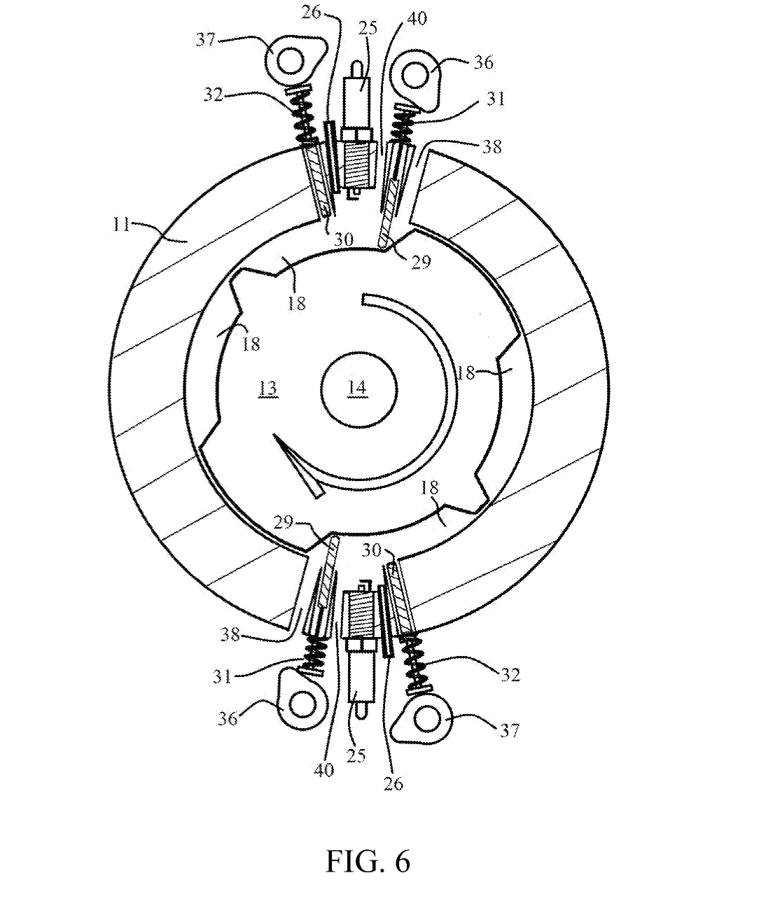

When operating in the pneumatic mode, the air intake passages 38 admit the introduction of compressed air into the engine 10. As seen in FIG. 6, as soon as the compression tongues 29 enter into the pressure grooves 18, compressed air is injected into the front space of the pressure grooves 18 through the opened air intake passages 38. At this point, the volumes of the front spaces are minimum. Expansion of the compressed air forces the pressure grooves 18 to move in the direction that makes the volumes of the front spaces to increase, therefore, pushes the pressure grooves 18 forward, and drives the rotor 13. The expansion of the compressed air can continue until the pressure grooves 18 completely pass the compression tongues 29. Meanwhile, the compressed air exhaust passages 40 are open, and moving of the compression tongues 29 along the pressure grooves 18 rearwardly clear the exhaust gases through the compressed exhaust passages 40. The compressed air exhaust passages 40 are open at all time when the engine 10 runs in the pneumatic mode.

What is claimed is:

1. A rotary engine able to produce mechanical energy from internal combustion and from pneumatic, steam and pressurized fluid flow, comprising:
a housing having an internal cylindrical contour wall, including at least one side plate connected to the housing;
at least one rotor positioned in and movable in the housing, having an axis of rotation, and having at least one pressure groove cut in said rotor;
at least one central shaft coaxial with the housing axis, connecting to the rotor and extending out of the housing, supported by at least one bearing in at least one of the side plates, and rotating with the rotor;
at least one slot cut through the housing contour wall, accepting a tongue reciprocating in sealing relationship to and within said slot;
at least one intake passage in the housing; and
at least one exhaust passage in the housing.

2. A rotary engine as defined in claim 1, wherein when used as pneumatic, steam and pressurized fluid engine, wherein the intake passages are located in the front of the slots and the exhaust passages are located at the rear of the slots.

3. A rotary engine as described in claim 1, wherein when used as internal combustion engine, further comprising:
at least one combustion chamber cut into the internal housing contour wall;
at least one compression slot located at the front of each of the combustion chamber, accepting a compression tongue reciprocating within said compression slot;
at least one combustion slot located at the rear of each of the combustion chamber, accepting a combustion tongue reciprocating within said combustion slot;
at least one spark plug mounted on the housing and projected into the combustion chamber, and is for creating sparks in the combustion chamber;
at least one fuel injector located on the housing, and injecting a combustible fuel into the combustion chamber;
at least one air intake passage in the housing located at the front of each of the compression slot; and
at least one fuel exhaust passage in the housing located at the rear of each of the combustion slot.

4. A rotary engine as defined in claim 1, further comprising:
at least one camshaft for operating the tongues into the slots;
at least one return spring for pushing each of the tongues out of the housing;
at least a set of valves for controlling the passages of fluids/gases through the intake passages and exhaust passages; and
at least one camshaft for operating the valves.

5. A rotary engine as claimed in claim 1, wherein the housing contour wall forms a seal with the rotor.

6. A rotary engine as described in claim 1, wherein the tongues form seals with their respective slots and with the pressure grooves when sliding in and out.

7. A rotary engine in accordance with claim 1, wherein said rotor being of cylindrical shape with a diameter approximately equal to the internal diameter of the housing.

8. A rotary engine comprising:
a housing having an internal cylindrical contour wall, including at least one side plate connected to the housing;
at least one rotor positioned in and movable in the housing, having an axis of rotation, and having at least one pressure groove cut in said rotor;
at least one central shaft coaxial with the housing axis, connecting to the rotor and extending out of the housing, supported by at least one bearing in at least one of the side plates, and rotating with the rotor;
at least one slot cut through the housing contour wall, accepting a tongue reciprocating in sealing relationship to and within said slot;
at least one intake passage in the housing; and
at least one exhaust passage in the housing.

9. A rotary engine as defined in claim 8, wherein when used as pneumatic, steam and pressurized fluid engine, wherein the intake passages are located in the front of the slots and the exhaust passages are located at the rear of the slots.

10. A rotary engine as described in claim 8, wherein when used as internal combustion engine, further comprising:
at least one combustion chamber cut into the internal housing contour wall;
at least one compression slot located at the front of each of the combustion chamber, accepting a compression tongue reciprocating within said compression slot;
at least one combustion slot located at the rear of each of the combustion chamber, accepting a combustion tongue reciprocating within said combustion slot;
at least one spark plug mounted on the housing and projected into the combustion chamber, and is for creating sparks in the combustion chamber;
at least one fuel injector located on the housing, and injecting a combustible fuel into the combustion chamber;
at least one air intake passage in the housing located at the front of each of the compression slot; and
at least one fuel exhaust passage in the housing located at the rear of each of the combustion slot.

11. A rotary engine as defined in claim 8, further comprising:
at least one camshaft for operating the tongues into the slots;
at least one return spring for pushing each of the tongues out of the housing;
at least a set of valves for controlling the passages of fluids/gases through the intake passages and exhaust passages; and
at least one camshaft for operating the valves.

12. A rotary engine as claimed in claim 8, wherein the housing contour wall forms a seal with the rotor.

13. A rotary engine as described in claim 8, wherein the tongues form seals with their respective slots and with the pressure grooves when sliding in and out.

14. A rotary engine in accordance with claim 8, wherein said rotor made of at least one pie shaped element having at least one hole through which the elements slidably mounted on at least one bar radiating from the central shaft.

15. A rotary engine as defined in claim 14, wherein the elements pushed away from the central shaft and against the housing wall by springs located between the central shaft and the elements.
